(19) United States
(12) Patent Application Publication
(10) Pub. No.: US 2005/0165617 A1
(43) Pub. Date: Jul. 28, 2005

(54) Transaction-based storage operations

(76) Inventors: Brian L. Patterson, Boise, ID (US); Brian S. Bearden, Boise, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/767,356

(22) Filed: Jan. 28, 2004

(51) Int. Cl. G06F 17/60

(52) U.S. Cl. 705/1

(57) ABSTRACT

Systems and methods for implementing transaction-based storage operations are disclosed. In one implementation a processor in a storage network receives a service request, executes the service request, and updates an account to reflect execution of the service request. In another implementation the processor may generate a token request for a service token and transmit the token request to a server communicatively connected to the storage network. The server validates the token request and transmits to the processor a response to the token request. The processor may invoke a service call if the response to the token request comprises at least one service token.

### TECHNICAL FIELD

The described subject matter relates to electronic computing, and more particularly to systems and methods for implementing transaction-based storage operations.

### BACKGROUND

Computer-based storage devices such as, e.g., SAN (storage area network) disk arrays or RAID (Redundant Array of Independent Disks) devices implement a set of operational features such as, e.g., data redundancy operations, data mirroring operations, or recovery operations. These operations may be implemented as logical instructions on a processing unit in the storage device, as firmware implemented in a configurable processor, or even as hardware-specific instructions.

Purchase of a storage device typically comprises a license for unlimited use of the feature set provided with the storage device. The cost of the selected features is incorporated into the cost of the storage device. Feature sets may be updated, e.g., by downloading revised instruction sets over a suitable communication network, typically for a fee.

This arrangement is suitable for some users of computer-based storage devices. Other users of computer-based storage devices may prefer a more flexible arrangement for obtaining operational features associated with storage equipment.

### SUMMARY

Systems and methods described herein permit computer-based storage devices to implement transaction-based storage services, in which a transaction fee is associated with the execution of a particular service. In one exemplary implementation, a method of implementing fee-based storage services is provided. The method comprises receiving, at a processor in a storage device, a service request; executing the service request; and transmitting, to an account server, information identifying an account associated with the processor and the service request.

### BRIEF DESCRIPTION OF THE DRAWINGS

FIG. 1 is a schematic illustration of an exemplary implementation of a networked computing system that utilizes a storage network;

FIG. 2 is a schematic illustration of an exemplary implementation of a storage network;

FIG. 3 is a schematic illustration of an exemplary implementation of a computing device that can be utilized to implement a host;

FIG. 4 is a schematic illustration of an exemplary implementation of a storage cell;

FIG. 5 is a schematic illustration of an exemplary implementation of a data storage system that implements RAID storage;

FIG. 6 is a schematic illustration of an exemplary implementation of a RAID controller in more detail;

FIG. 7 is a flowchart illustrating operations in an exemplary implementation of a method for transaction-based storage operations; and

FIG. 8 is a flowchart illustrating operations in another exemplary implementation of transaction-based storage operations.

### DETAILED DESCRIPTION

Described herein are exemplary storage network architectures and methods for implementing transaction-based storage operations. The methods described herein may be embodied as logic instructions on a computer-readable medium. When executed on a processor, the logic instructions cause a general purpose computing device to be programmed as a special-purpose machine that implements the described methods. The processor, when configured by the logic instructions to execute the methods recited herein, constitutes structure for performing the described methods.

Exemplary Network Architecture

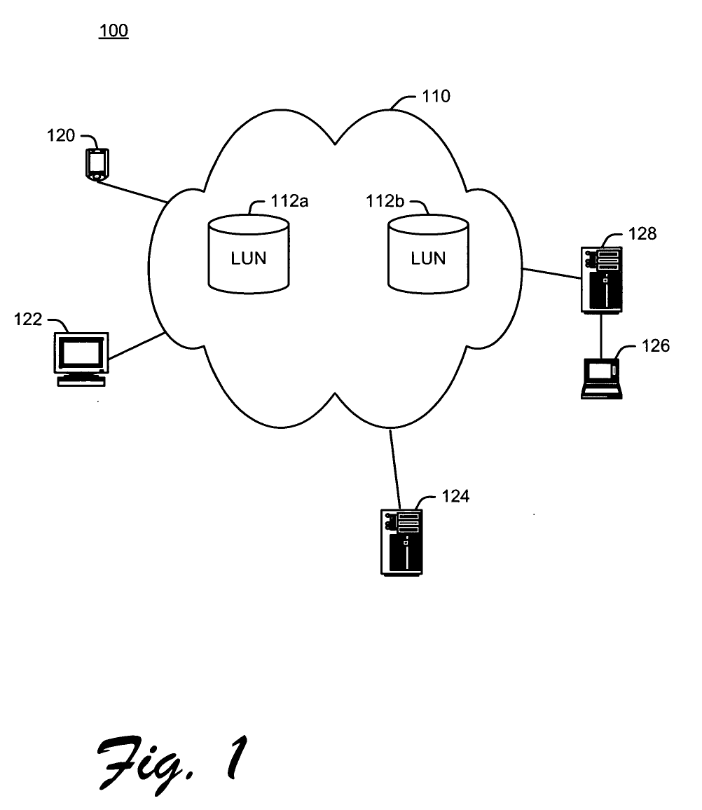

FIG. 1 is a schematic illustration of an exemplary implementation of a networked computing system 100 that utilizes a storage network. The storage network comprises a storage pool 110, which comprises an arbitrarily large quantity of storage space. In practice, a storage pool 110 has a finite size limit determined by the particular hardware used to implement the storage pool 110. However, there are few theoretical limits to the storage space available in a storage pool 110.

A plurality of logical disks (also called logical units or LUNs) 112a, 112b may be allocated within storage pool 110. Each LUN 112a, 112b comprises a contiguous range of logical addresses that can be addressed by host devices 120, 122, 124 and 128 by mapping requests from the connection protocol used by the host device to the uniquely identified LUN 112. As used herein, the term “host” comprises a computing system(s) that utilize storage on its own behalf, or on behalf of systems coupled to the host. For example, a host may be a supercomputer processing large databases or a transaction processing server maintaining transaction records. Alternatively, a host may be a file server on a local area network (LAN) or wide area network (WAN) that provides storage services for an enterprise. A file server may comprise one or more disk controllers and/or RAID controllers configured to manage multiple disk drives. A host connects to a storage network via a communication connection such as, e.g., a Fibre Channel (FC) connection.

A host such as server 128 may provide services to other computing or data processing systems or devices. For example, client computer 126 may access storage pool 110 via a host such as server 128. Server 128 may provide file services to client 126, and may provide other services such as transaction processing services, email services, etc. Hence, client device 126 may or may not directly use the storage consumed by host 128.

Devices such as wireless device 120, and computers 122, 124, which are also hosts, may logically couple directly to LUNs 112a, 112b. Hosts 120-128 may couple to multiple LUNs 112a, 112b, and LUNs 112a, 112b may be shared among multiple hosts. Each of the devices shown in FIG. 1 may include memory, mass storage, and a degree of data processing capability sufficient to manage a network connection.

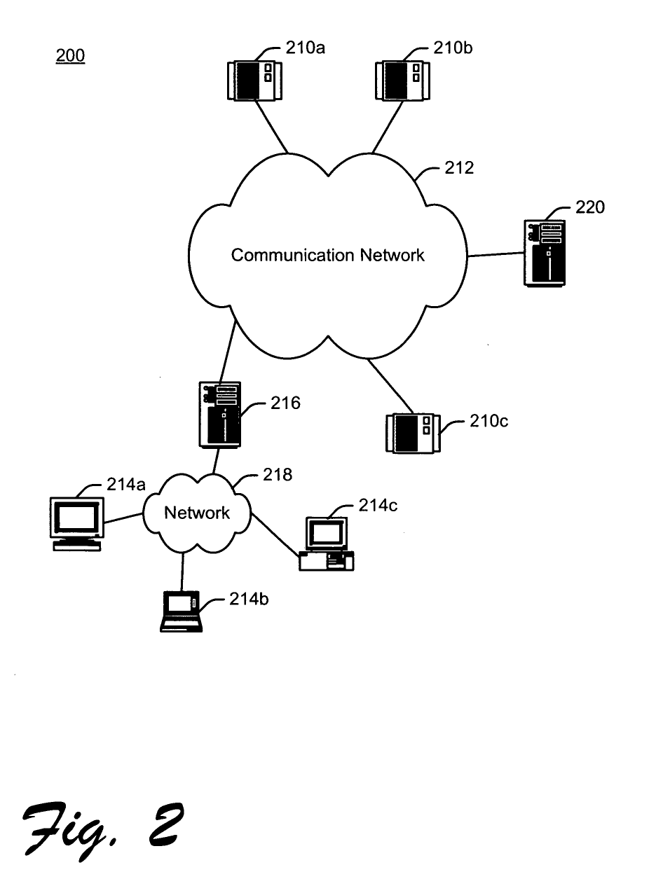

FIG. 2 is a schematic illustration of an exemplary storage network 200 that may be used to implement a storage pool such as storage pool 110. Storage network 200 comprises a plurality of storage cells 210a, 210b, 210c connected by a communication network 212. Storage cells 210a, 210b, 210c may be implemented as one or more communicatively connected storage devices. Exemplary storage devices include the STORAGEWORKS line of storage devices commercially available form Hewlett-Packard Corporation of Palo Alto, Calif., USA. Communication network 212 may be implemented as a private, dedicated network such as, e.g., a Fibre Channel (FC) switching fabric. Alternatively, portions of communication network 212 may be implemented using public communication networks pursuant to a suitable communication protocol such as, e.g., the Internet Small Computer Serial Interface (iSCSI) protocol.

Client computers 214a, 214b, 214c may access storage cells 210a, 210b, 210c through a host, such as servers 216, 220. Clients 214a, 214b, 214c may be connected to file server 216 directly, or via a network 218 such as a Local Area Network (LAN) or a Wide Area Network (WAN). The number of storage cells 210a, 210b, 210c that can be included in any storage network is limited primarily by the connectivity implemented in the communication network 212. By way of example, a switching fabric comprising a single FC switch can interconnect 256 or more ports, providing a possibility of hundreds of storage cells 210a, 210b, 210c in a single storage network.

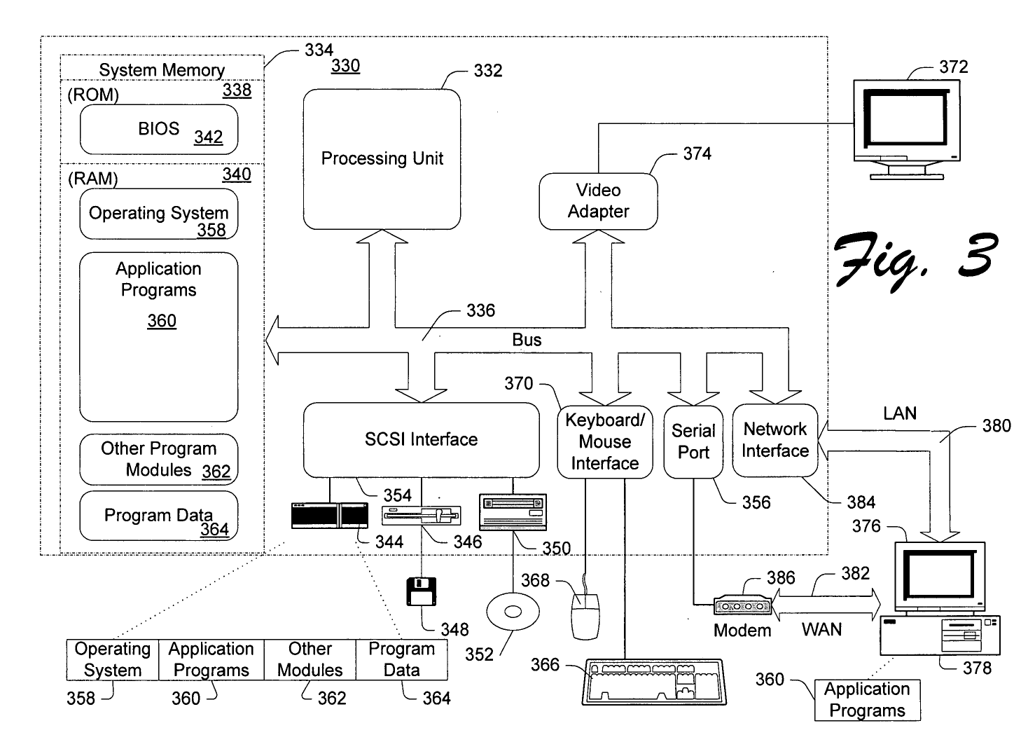

Hosts 216, 220 are typically implemented as server computers. FIG. 3 is a schematic illustration of an exemplary computing device 330 that can be utilized to implement a host. Computing device 330 includes one or more processors or processing units 332, a system memory 334, and a bus 336 that couples various system components including the system memory 334 to processors 332. The bus 336 represents one or more of any of several types of bus structures, including a memory bus or memory controller, a peripheral bus, an accelerated graphics port, and a processor or local bus using any of a variety of bus architectures. The system memory 334 includes read only memory (ROM) 338 and random access memory (RAM) 340. A basic input/output system (BIOS) 342, containing the basic routines that help to transfer information between elements within computing device 330, such as during start-up, is stored in ROM 338.

Computing device 330 further includes a hard disk drive 344 for reading from and writing to a hard disk (not shown), and may include a magnetic disk drive 346 for reading from and writing to a removable magnetic disk 348, and an optical disk drive 350 for reading from or writing to a removable optical disk 352 such as a CD ROM or other optical media. The hard disk drive 344, magnetic disk drive 346, and optical disk drive 350 are connected to the bus 336 by a SCSI interface 354 or some other appropriate interface. The drives and their associated computer-readable media provide nonvolatile storage of computer-readable instructions, data structures, program modules and other data for computing device 330. Although the exemplary environment described herein employs a hard disk, a removable magnetic disk 348 and a removable optical disk 352, other types of computer-readable media such as magnetic cassettes, flash memory cards, digital video disks, random access memories (RAMs), read only memories (ROMs), and the like, may also be used in the exemplary operating environment.

A number of program modules may be stored on the hard disk 344, magnetic disk 348, optical disk 352, ROM 338, or RAM 340, including an operating system 358, one or more application programs 360, other program modules 362, and program data 364. A user may enter commands and information into computing device 330 through input devices such as a keyboard 366 and a pointing device 368. Other input devices (not shown) may include a microphone, joystick, game pad, satellite dish, scanner, or the like. These and other input devices are connected to the processing unit 332 through an interface 370 that is coupled to the bus 336. A monitor 372 or other type of display device is also connected to the bus 336 via an interface, such as a video adapter 374.

Computing device 330 may operate in a networked environment using logical connections to one or more remote computers, such as a remote computer 376. The remote computer 376 may be a personal computer, a server, a router, a network PC, a peer device or other common network node, and typically includes many or all of the elements described above relative to computing device 330, although only a memory storage device 378 has been illustrated in FIG. 3. The logical connections depicted in FIG. 3 include a LAN 380 and a WAN 382.

When used in a LAN networking environment, computing device 330 is connected to the local network 380 through a network interface or adapter 384. When used in a WAN networking environment, computing device 330 typically includes a modem 386 or other means for establishing communications over the wide area network 382, such as the Internet. The modem 386, which may be internal or external, is connected to the bus 336 via a serial port interface 356. In a networked environment, program modules depicted relative to the computing device 330, or portions thereof, may be stored in the remote memory storage device. It will be appreciated that the network connections shown are exemplary and other means of establishing a communications link between the computers may be used.

Hosts 216, 220 may include host adapter hardware and software to enable a connection to communication network 212. The connection to communication network 212 may be through an optical coupling or more conventional conductive cabling depending on the bandwidth requirements. A host adapter may be implemented as a plug-in card on computing device 330. Hosts 216, 220 may implement any number of host adapters to provide as many connections to communication network 212 as the hardware and software support.

Generally, the data processors of computing device 330 are programmed by means of instructions stored at different times in the various computer-readable storage media of the computer. Programs and operating systems may distributed, for example, on floppy disks, CD-ROMs, or electronically, and are installed or loaded into the secondary memory of a computer. At execution, the programs are loaded at least partially into the computer's primary electronic memory.

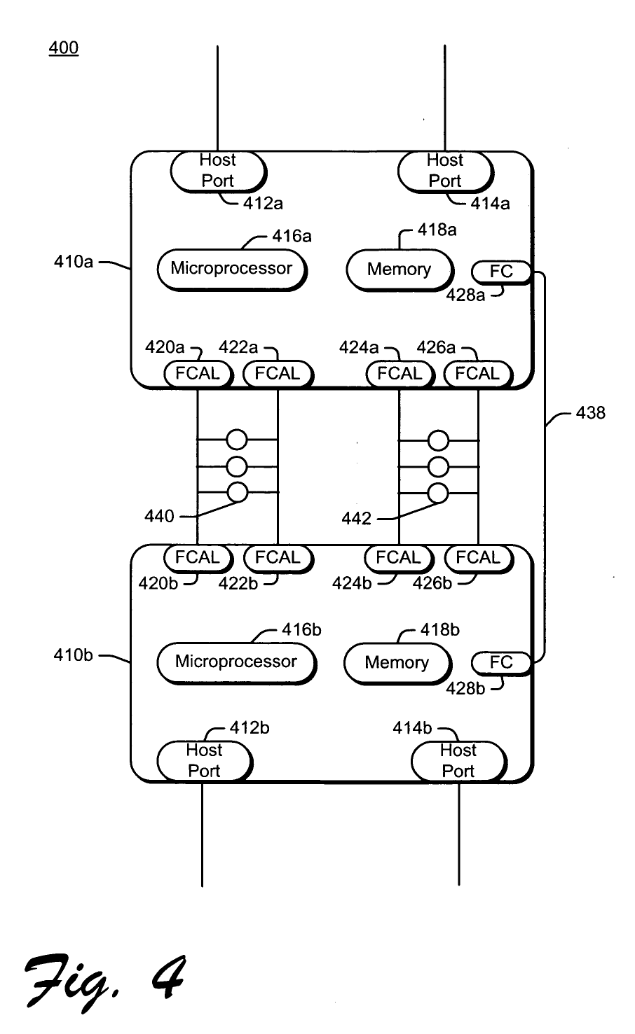

FIG. 4 is a schematic illustration of an exemplary implementation of a storage cell 400 that may be used to implement a storage cell such as 210a, 210b, or 210c. Referring to FIG. 4, storage cell 400 includes two Network Storage Controllers (NSCs), also referred to as disk array controllers, 410a, 410b to manage the operations and the transfer of data to and from one or more disk drives 440, 442. NSCs 410a, 410b may be implemented as plug-in cards having a microprocessor 416a, 416b, and memory 418a, 418b. Each NSC 410a, 410b includes dual host adapter ports 412a, 414a, 412b, 414b that provide an interface to a host, i.e., through a communication network such as a switching fabric. In a Fibre Channel implementation, host adapter ports 412a, 412b, 414a, 414b may be implemented as FC N_Ports. Each host adapter port 412a, 412b, 414a, 414b manages the login and interface with a switching fabric, and is assigned a fabric-unique port ID in the login process. The architecture illustrated in FIG. 4 provides a fully-redundant storage cell; only a single NSC is required to implement a storage cell.

Each NSC 410a, 410b further includes a communication port 428a, 428b that enables a communication connection 438 between the NSCs 410a, 410b. The communication connection 438 may be implemented as a FC point-to-point connection, or pursuant to any other suitable communication protocol.

In an exemplary implementation, NSCs 410a, 410b further include a plurality of Fiber Channel Arbitrated Loop (FCAL) ports 420a-426a, 420b-426b that implement an FCAL communication connection with a plurality of storage devices, e.g., arrays of disk drives 440, 442. While the illustrated embodiment implement FCAL connections with the arrays of disk drives 440, 442, it will be understood that the communication connection with arrays of disk drives 440, 442 may be implemented using other communication protocols. For example, rather than an FCAL configuration, a FC switching fabric or a small computer serial interface (SCSI) connection may be used.

In operation, the storage capacity provided by the arrays of disk drives 440, 442 may be added to the storage pool 110. When an application requires storage capacity, logic instructions on a host computer 128 establish a LUN from storage capacity available on the arrays of disk drives 440, 442 available in one or more storage sites. It will be appreciated that, because a LUN is a logical unit, not necessarily a physical unit, the physical storage space that constitutes the LUN may be distributed across multiple storage cells. Data for the application is stored on one or more LUNs in the storage network. An application that needs to access the data queries a host computer, which retrieves the data from the LUN and forwards the data to the application.

One or more of the storage cells 210a, 210b, 210c in the storage network 200 may implement RAID-based storage. RAID (Redundant Array of Independent Disks) storage systems are disk array systems in which part of the physical storage capacity is used to store redundant data. RAID systems are typically characterized as one of six architectures, enumerated under the acronym RAID. A RAID 0 architecture is a disk array system that is configured without any redundancy. Since this architecture is really not a redundant architecture, RAID 0 is often omitted from a discussion of RAID systems.

A RAID 1 architecture involves storage disks configured according to mirror redundancy. Original data is stored on one set of disks and a duplicate copy of the data is kept on separate disks. The RAID 2 through RAID 5 architectures all involve parity-type redundant storage. Of particular interest, a RAID 5 system distributes data and parity information across a plurality of the disks. Typically, the disks are divided into equally sized address areas referred to as “blocks”. A set of blocks from each disk that have the same unit address ranges are referred to as “stripes”. In RAID 5, each stripe has N blocks of data and one parity block, which contains redundant information for the data in the N blocks.

In RAID 5, the parity block is cycled across different disks from stripe-to-stripe. For example, in a RAID 5 system having five disks, the parity block for the first stripe might be on the fifth disk; the parity block for the second stripe might be on the fourth disk; the parity block for the third stripe might be on the third disk; and so on. The parity block for succeeding stripes typically “precesses” around the disk drives in a helical pattern (although other patterns are possible). RAID 2 through RAID 4 architectures differ from RAID 5 in how they compute and place the parity block on the disks. The particular RAID class implemented is not important.

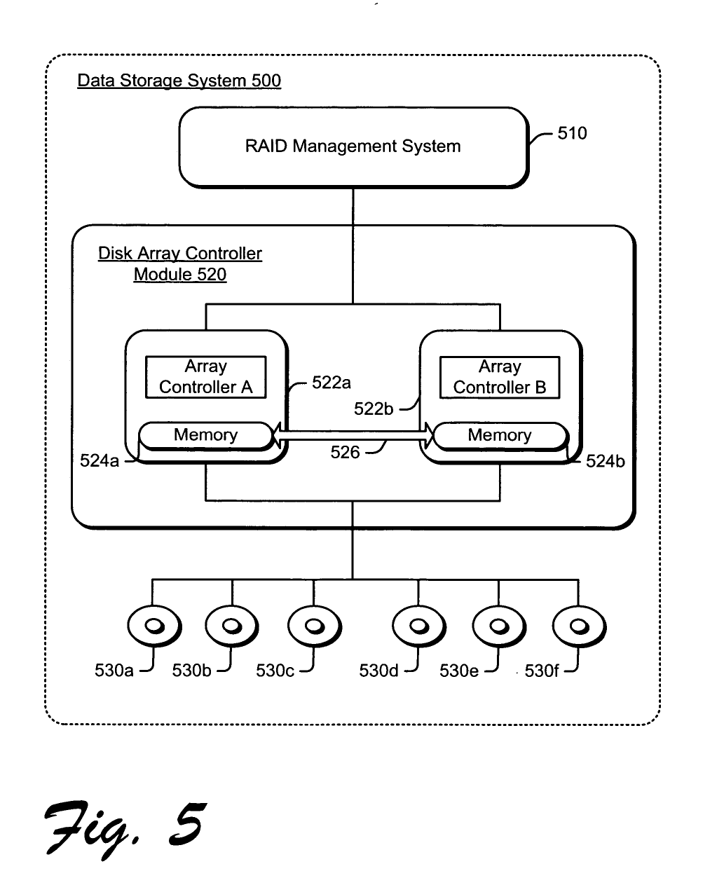

FIG. 5 is a schematic illustration of an exemplary implementation of a data storage system 500 that implements RAID storage. The data storage system 500 has a disk array with multiple storage disks 530a-530f, a disk array controller module 520, and a RAID management system 510. The disk array controller module 520 is coupled to multiple storage disks 530a-530f via one or more interface buses, such as a small computer system interface (SCSI) bus. The RAID management system 510 is coupled to the disk array controller module 520 via one or more interface buses. It is noted that the RAID management system 510 can be embodied as a separate component (as shown), or within the disk array controller module 520, or within a host computer. The RAID management system 510 may be implemented as a software module that runs on a processing unit of the data storage device, or on the processor unit 332 of the computer 330.

The disk array controller module 520 coordinates data transfer to and from the multiple storage disks 530a-530f. In an exemplary implementation, the disk array module 520 has two identical controllers or controller boards: a first disk array controller 522a and a second disk array controller 522b. Parallel controllers enhance reliability by providing continuous backup and redundancy in the event that one controller becomes inoperable. Parallel controllers 522a and 522b have respective mirrored memories 524a and 524b. The mirrored memories 524a and 524b may be implemented as battery-backed, non-volatile RAMs (NVRAMs). Although only dual controllers 522a and 522b are shown and discussed generally herein, aspects of this invention can be extended to other multi-controller configurations where more than two controllers are employed.

The mirrored memories 524a and 524b store several types of information. The mirrored memories 524a and 524b maintain duplicate copies of a cohesive memory map of the storage space in multiple storage disks 530a-530f. This memory map tracks where data and redundancy information are stored on the disks, and where available free space is located. The view of the mirrored memories is consistent across the hot-plug interface, appearing the same to external processes seeking to read or write data.

The mirrored memories 524a and 524b also maintain a read cache that holds data being read from the multiple storage disks 530a-530f. Every read request is shared between the controllers. The mirrored memories 524a and 524b further maintain two duplicate copies of a write cache. Each write cache temporarily stores data before it is written out to the multiple storage disks 530a-530f.

The controller's mirrored memories 522a and 522b are physically coupled via a hot-plug interface 526. Generally, the controllers 522a and 5222b monitor data transfers between them to ensure that data is accurately transferred and that transaction ordering is preserved (e.g., read/write ordering).

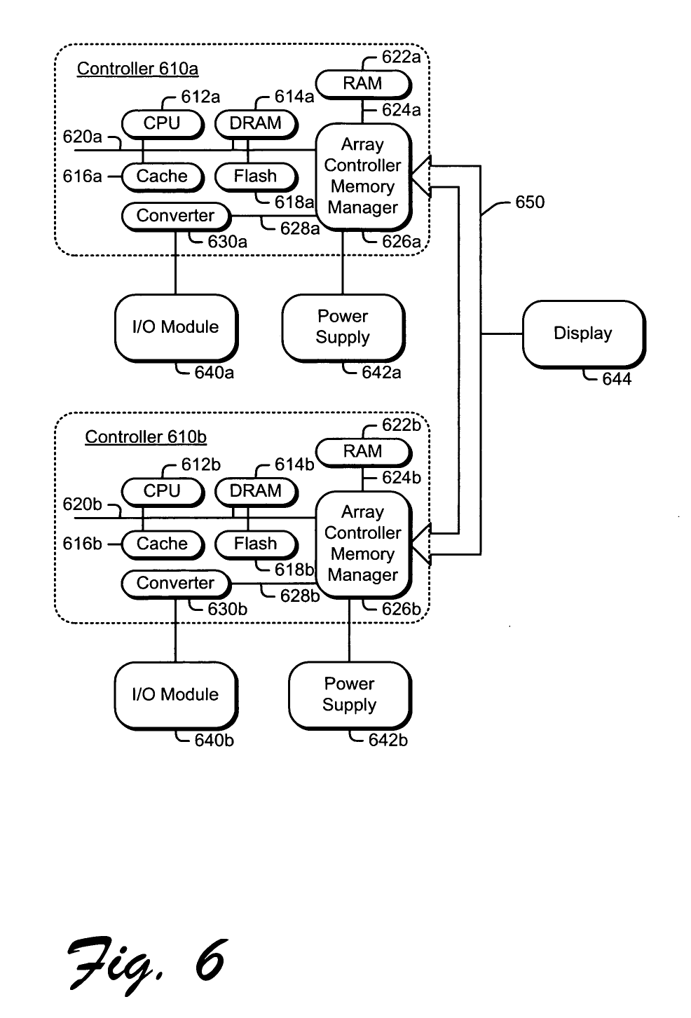

FIG. 6 is a schematic illustration of an exemplary implementation of a dual RAID controller in more detail. In addition to controller boards 610a and 610b, the disk array controller also has two I/O modules 640a and 640b, an optional display 644, and two power supplies 6642a and 642b. The I/O modules 640a and 640b facilitate data transfer between respective controllers 610a and 610b and a host computer, such as servers 216, 220. In one implementation, the I/O modules 640a and 640b employ fiber channel technology, although other bus technologies may be used. The power supplies 642a and 642b provide power to the other components in the respective disk array controllers 610a, 610b, the display 672, and the I/O modules 640a, 640b.

Each controller 610a, 610b has a converter 630a, 630b connected to receive signals from the host via respective I/O modules 640a, 640b. Each converter 630a and 630b converts the signals from one bus format (e.g., Fibre Channel) to another bus format (e.g., peripheral component interconnect (PCI)). A first PCI bus 628a, 628b carries the signals to an array controller memory transaction manager 626a, 626b, which handles all mirrored memory transaction traffic to and from the RAM 622a, 622b in the mirrored controller. The array controller memory transaction manager maintains the memory map, computes parity, and facilitates cross-communication with the other controller. The array controller memory transaction manager 626a, 626b is preferably implemented as an integrated circuit (IC), such as an application-specific integrated circuit (ASIC).

The array controller memory transaction manager 626a, 626b is coupled to the RAM 622a, 622b via a high-speed bus 622a, 622b and to other processing and memory components via a second PCI bus 620a, 620b. Each controller 610a, 610b has at least one processing unit 612a, 612b and several types of memory connected to the PCI bus 620a and 620b. The memory includes a dynamic RAM (DRAM) 614a, 614b, Flash memory 618a, 618b, and cache 616a, 616b.

The array controller memory transaction managers 626a and 626b are coupled to one another via a communication interface 650. The communication interface 650 supports bi-directional parallel communication between the two array controller memory transaction managers 626a and 626b at a data transfer rate commensurate with the RAM buses 624a and 624b.

The array controller memory transaction managers 626a and 626b employ a high-level packet protocol to exchange transactions in packets over hot-plug interface 650. The array controller memory transaction managers 626a and 626b perform error correction on the packets to ensure that the data is correctly transferred between the controllers.

The array controller memory transaction managers 626a and 626b provide a memory image that is coherent across the hot plug interface 650. The managers 626a and 626b also provide an ordering mechanism to support an ordered interface that ensures proper sequencing of memory transactions.

Exemplary Operations

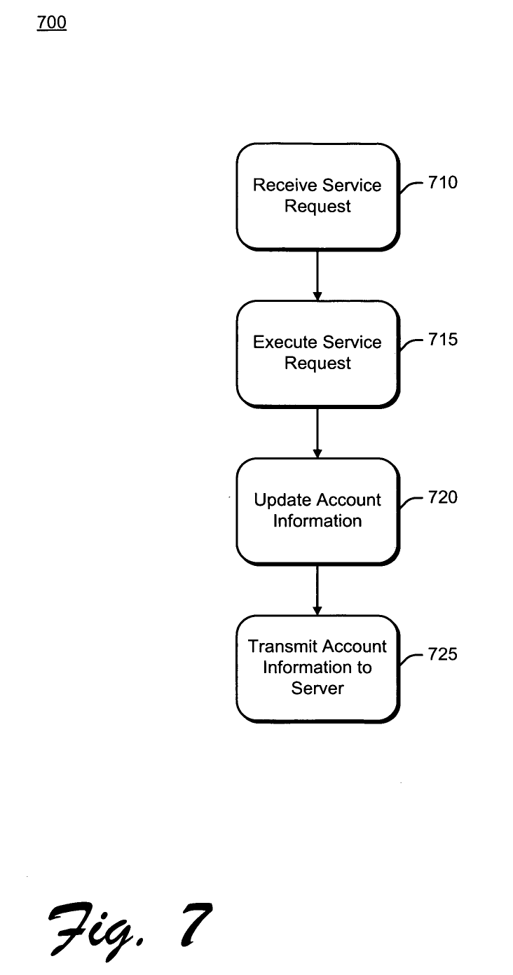

FIG. 7 is a flowchart illustrating operations in an exemplary implementation of a method for transaction-based storage operations. In one embodiment, the operations described in FIG. 7 may be implemented on a processing unit of a RAID controller, such as one of the processing units 612a, 612b of RAID controllers 610a, 610b depicted in FIG. 6. In alternate embodiments the operations described in FIG. 7 may be implemented in a network storage controller, a host computer, or another processor in a storage network.

At operation 710 a service request is received. The service request may have been generated by a user of the storage device or network, e.g., a network administrator. Alternatively, the service request may be generated by another computing device in the storage device or network, or by a process executing on the processor that executes the operations of FIG. 7. The service request may include information that identifies a specific service to be executed, and may include information identifying the processor or controller on which the service is to be executed, the data storage unit on which the service is to be performed, and an account to which a fee for the operation is to be charged.

The particular nature of the service request is not critical. Exemplary services that may include a snapshot operation in which data maps for a first data storage unit, e.g., LUN or a RAID disk array, are copied to a redundant storage unit; a snapclone operation in which data from a first data storage unit, e.g., LUN or a RAID disk array, is copied to a redundant storage unit. Alternatively, the service request may be for remote copy or mirroring operations in which data from a first data storage unit, e.g., LUN or a RAID disk array, is copied to a remote storage unit. The remote copy or mirroring operations may write the entire data storage unit, or may execute synchronous (or asynchronous) write operations to keep the source data and the remote copy in a consistent data state. Other suitable service requests include requests for LUN extensions, which increases the size of LUNs, error detection algorithms, or data map recovery operations.

In other implementations the service request may include a service level indicator that indicates a desired level of service for a particular operational feature. Multiple service levels may be provided, and the transaction fee for each level of service may vary. Again, the particular operational feature is not critical. By way of example, multiple processing and/or data transmission algorithms of differing efficiency may be offered, and the transaction fee may vary as a function of the efficiency of the algorithm. Alternatively, or in addition, firmware upgrades, e.g., for non-volatile RAM recovery, may be offered on-line (i.e., when a storage device is operational) or off-line (i.e., when a storage device is not operational), and the transaction fee may vary based on the selection.

Another service level offering is described in U.S. patent application Ser. No. 10/457,868 by Brian L. Patterson et al., entitled “Method and Apparatus for Selecting Among Multiple Data Reconstruction Techniques”, and assigned to Hewlett-Packard Company, the entire contents of which are incorporated herein by reference. Multiple data reconstruction techniques may be offered to recover from device failures, and different transaction fees may be allocated to the different reconstruction techniques. For example, an administrator may select a “rebuild in place” technique as a preferred reconstruction technique, but may choose to permit a “migrating rebuild” reconstruction technique if the rebuild in place technique is not available. In the event of failure, the storage device may first attempt to implement the preferred technique, and if the preferred technique is not available, then may implement another technique.

At operation 715 the service request is executed. In an exemplary implementation the processor invokes a software application to execute the service call.

At operation 720 account information is updated to reflect execution of the service request. In an exemplary implementation account information is maintained in a memory location communicatively connected to the processor. In a RAID controller, account information may be maintained on the RAID disk array. The account information may include an account identifier, a service identifier, a device identifier that identifies the specific network device or controller that executed the service, a time stamp that identifies the date and time the service was executed.

In operation 725 account information is transmitted to a remote server over a suitable communication connection, e.g., a communication network or a dedicated communication link. In one implementation operation 725 is executed each time a service request is executed. In an alternate implementation an account may accrue a debit or credit balance, so that multiple service requests may be executed before operation 725 is implemented.

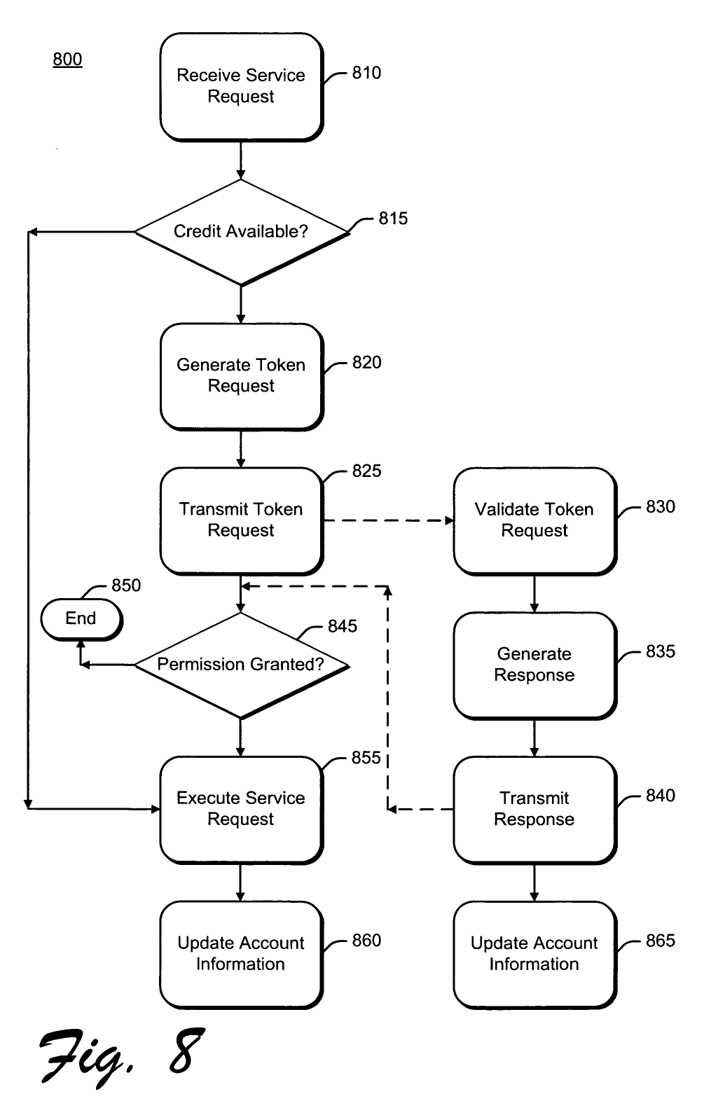

Operations 710-725 permit a storage device to implement transaction-based storage operations without the involvement of a remote processor. FIG. 8 is a flowchart illustrating operations in an alternate implementation of a method for transaction-based storage operations. The operations described in FIG. 8 may be implemented on a RAID controller, in a network storage controller, a host computer, or another processor in a storage network. The operations in FIG. 8 implement a client-server based method, in which a processor on a local controller may cooperate with a remote server to implement transaction-based storage operations.

At operation 810 a service request is received. The service request may have been generated by a user of the storage device or network, e.g., a network administrator. Alternatively, the service request may be generated by another computing device in the storage device or network, or by a process executing on the processor that executes the operations of FIG. 8. The contents of the service request may be substantially as described above, in connection with FIG. 7. The particular service requested is not critical. Exemplary service requests are described in connection with FIG. 7.

At optional operation 815 it is determined whether there is sufficient credit in an account stored on a local storage medium to execute the service request. In a credit-based system a controller may maintain an account on a local storage medium that can have a debit or a credit balance. The unit of account is not critical; the account may be denominated in currency units, points, or other units. If the account balance (or the available credit) does not exceed the fee associated with the service request, then sufficient credit is available in the account stored on a local storage medium and control may pass to operation 855, at which the service request is executed, e.g., by invoking a software application. In this event, the transaction-based storage operation may be managed without the assistance of the remote server. Control then passes to operation 860, at which the local account information is updated to reflect execution of the storage operation.

By contrast, if there is insufficient credit in the local account to execute the service request, then control passes to operation 820 and a token request is generated. In one implementation, the RAID controller (or other processor executing the method of FIG. 8) and the server use a token-based communication model, in which the RAID controller (or other processor executing the method of FIG. 8) requests permission, in the form of a token, from the server to execute the service request. The token request may include an account identifier for an account to which the fee for executing the service request is to be charged. In addition, the token request may include information identifying the service request, information identifying the network device that originated the service request, and information about the credit available in the account stored on a local storage medium.

At operation 825 the token request is transmitted to the server. The request may be transmitted over any suitable communication connection. In a storage network such as storage network 200 the token request may be transmitted across the communication network 212. In an alternate implementation the token request may be transmitted over a dedicated communication link between the RAID controller (or other processor executing the method of FIG. 8) and the server. By way of example, it is common for RAID arrays to maintain a dedicated phone or data link between the RAID array and a remote server for purposes of maintenance. The token request may be transmitted over this dedicated communication link.

The server receives the token request and, at operation 830, the server validates the token request. In an exemplary implementation the server comprises a software application that maintains data tables that record the status of one or more service accounts. The data tables may be implemented in, e.g., a relational database or any other suitable data model. The data tables maintained on the server may include customer numbers, account numbers, device identifiers, and other information about devices and services.

In one implementation the server may compare the account identifier in the token request with the list of account identifiers maintained in the data tables on the server. If there is not a matching account identifier in the data tables, then the server may decline to validate the service request. By contrast, if there is a matching entry in the data tables, then the server may optionally execute further validation operations. For example, the server may search its data tables for a device identifier that matches the device identifier included in the token request, and may confirm an association between the device identifier and the account identifier.

The server may also determine whether the account identified in the token request comprises sufficient credit to receive a token. In an exemplary implementation the accounts maintained on the server may have a debit balance or a credit balance. The server may compare the fee associated with the service request with the credit available in the account. If there is insufficient credit in the account to pay the fee associated with the service request, then the server may optionally undertake operations to provide the account with sufficient credit. By way of example, the server may review the account's payment history or may retrieve information from a third-party credit bureau to determine whether additional credit should be added to the account.

If there is sufficient credit in the account to pay the fee associated with the service, then the server may generate a token authorizing execution of the service request. The particular form of the token takes is not critical, and may be implementation-specific. In one implementation the token may include a data field comprising a flag that indicates permission to execute the service request has been granted or denied. In alternate implementations the token may include an account identifier and/or account balance information. The token may also include a code, decipherable by the processor, granting or denying permission to invoke the service call. The code may be encrypted to provide a measure of confidentiality between the processor and the server. In an alternate implementation, the token may include a software module, executable by the processor, for invoking the service request. The software module may be embodied as an applet, such as a JAVA applet, that may be executed on the processor.

At operation 840 the server transmits a response to the token request to the RAID controller (or other processor executing the method of FIG. 8). The response may be transmitted across a suitable communication link(s), as described above. The response to the token request includes a token and may include additional information such as, e.g., a time stamp.

The RAID controller (or other processor) receives the response to the token request and, at operation 845, evaluates the response to determine if the token grants permission to execute the service request. The evaluation operation implemented is a function of the format of the token. If the token is implemented as a data field, then the evaluation may require interpreting the value in the data field to determine whether the data field grants or denies permission to execute the service request. If the token is implemented as a code, then the evaluation may require deciphering and/or decrypting the code to determine whether the data field grants or denies permission to execute the service request. If the token is implemented as a software module, then the evaluation may require determining whether the response includes a software module, and if so then executing the software module on the RAID controller (or other processor). The particular nature of the evaluation is not critical, and is implementation-specific.

If the response to the token request denies permission to execute the service request, then the method defined in FIG. 8 ends at operation 850. By contrast, if the response to the token request grants permission to execute the service request, then control passes to operation 855, and the service request is executed. In an exemplary implementation the processor invokes a software application to execute the service call.

At optional operation 860 the RAID controller (or other processor) updates the information in the account stored on a local storage medium to reflect execution of the service request and/or other account changes resulting from the token request to the server. By way of example, if the server increased the credit available to the RAID controller (or other processor), then the information in the account stored on a local storage medium may be updated to reflect this change.

Similarly, at optional operation 865 the account information stored on the server is updated to reflect execution of the service request and/or other changes in the account status. For example, if an account is determined to be delinquent, then its credit status may be restricted to limit or deny use of services.

Although the described arrangements and procedures have been described in language specific to structural features and/or methodological operations, it is to be understood that the subject matter defined in the appended claims is not necessarily limited to the specific features or operations described. Rather, the specific features and operations are disclosed as preferred forms of implementing the claimed present subject matter.

1. A method of computing, comprising:
at a processor in a storage network:
receiving a service request;
generating, in response to the received service request, a token request for a service token;
transmitting the token request to a server communicatively connected to the storage network; and
at the server:
validating the token request;
transmitting to the processor a response to the validated token request; and
invoking, at the processor in the storage network, a service call if the response to the token request includes at least one service token.

2. The method of claim 1, wherein the service request is generated by at least one of a user of a device in the storage network or by a processor communicatively connected to the storage network.

3. The method of claim 1, wherein the service request comprises a request for at least one of a data mirroring service, a remote copy service, a back-up service, a recovery service, or a LUN extension service.

4. The method of claim 1, wherein generating a token request comprises retrieving at least one account identifier for an account associated with a device in the storage network.

5. The method of claim 4, wherein generating a token request comprises incorporating into the token request information identifying the service request.

6. The method of claim 5, wherein validating the token request comprises validating the at least one account identifier associated with the service request.

7. The method of claim 5, wherein validating the token request comprises determining whether the account associated with the at least one account identifier comprises sufficient credit to receive a token.

8. The method of claim 7, further comprising retrieving information from a third-party credit bureau.

9. The method of claim 1, wherein the response to the token request comprises at least one of:
an account identifier;
an account balance;
a code, decipherable by the processor, granting or denying permission to invoke the service call; and
a software module, executable by the processor, for invoking the service call.

10. The method of claim 1, further comprising updating account information at the processor in the storage network.

11. A method of implementing fee-based storage services, comprising:
receiving, at a processor in a storage device, a service request;
executing the service request; and
transmitting, to an account server, information identifying an account associated with the processor and the service request.

12. The method of claim 11, wherein the service request comprises a request for at least one of a data mirroring service, a remote copy service, a back-up service, a recovery service, or a LUN extension service.

13. The method of claim 11, wherein the processor maintains account information associated with one or more storage devices, and wherein the processor updates account information to reflect execution of the service request.

14. The method of claim 11, further comprising receiving, from the account server a response comprising at least one of:
an account identifier;
an account balance;
a code, decipherable by the processor, granting or denying permission to invoke the service call; and
a software module, executable by the processor, for invoking the service call.

15. A method of implementing fee-based storage services, comprising:
receiving, at a server communicatively connected to at least one storage device, a token request including information identifying an account associated with the storage device;
validating the token request; and
transmitting, to the storage device, a response to the token request, wherein the response includes at least one of:
an account identifier;
an account balance;
a code, decipherable by the processor, granting or denying permission to invoke the service call; and
a software module, executable by the processor, for invoking the service call.

16. The method of claim 15, wherein validating the token request comprises validating the information identifying an account associated with the service request.

17. The method of claim 15, wherein validating the token request comprises determining whether an account associated with the service request comprises sufficient credit to receive a token.

18. The method of claim 17, further comprising retrieving information from a third-party credit bureau.

19. A method of implementing fee-based storage services, comprising:
receiving, at a processor in a storage device, a service request;
executing the service request; and
updating an account to reflect execution of the service request.

20. The method of claim 19, wherein the service request is generated by at least one of a user of a device in the storage network or by a processor communicatively connected to the storage network.

21. The method of claim 19, wherein the service request comprises a request for at least one of a data mirroring service, a remote copy service, a back-up service, a recovery service, or a LUN extension service.

22. The method of claim 19, further comprising transmitting account information to a remote server.

23. A computer-based data storage device, comprising:
means for providing access to data storage;
means for enabling communication with one or more remote computing devices;
account management means for managing account information associated with the computer-based storage device; and
processing means for receiving a service request and executing the service request based on input from the account management means or a remote computing device.

24. The computer-based data storage device of claim 23, wherein the means for providing access to data storage comprises a disk controller.

25. The computer-based data storage device of claim 23, wherein the means for providing access to data storage comprises a RAID controller.

26. The computer-based data storage device of claim 23, wherein the means for enabling communication with one or more remote computing devices comprises a I/O module.

27. The computer-based data storage device of claim 23, wherein the account management means comprise means for updating the balance of an account stored on a local storage medium.

28. The computer-based data storage device of claim 23, wherein the processing means comprise means for determining whether an account stored on a local storage medium comprises sufficient credit to execute the service request.

29. The computer-based data storage device of claim 23, wherein the processing means comprises means for requesting permission from a remote computing device to execute the service request.

30. A method of implementing fee-based storage services, comprising:
receiving, at a processor in a storage network, a service request;
generating a token request for a service token;
transmitting the token request to a server communicatively connected to the storage network; and
invoking a service call at the processor if the response to the token request comprises at least one token granting permission to execute the service request.

31. The method of claim 30, wherein the service request is generated by at least one of a user of a device in the storage network or by a processor communicatively connected to the storage network.

32. The method of claim 30, wherein the service request comprises a request for at least one of a data mirroring service, a remote copy service, a back-up service, a recovery service, or a LUN extension service.

33. The method of claim 30, wherein the response to the token request comprises at least one of:
an account identifier;
an account balance;
a code, decipherable by the processor, granting or denying permission to invoke the service call; and
a software module, executable by the processor, for invoking the service call.

34. The method of claim 30, further comprising updating account information at the processor in the storage network.
